(19) United States
(12) Patent Application Publication
(10) Pub. No.: US 2013/0019314 A1
(43) Pub. Date: Jan. 17, 2013

(54) INTERACTIVE VIRTUAL PATCHING USING A WEB APPLICATION SERVER FIREWALL

(71) Applicants: Peng Ji, Beijing (CN); Lin Luo, Beijing (CN); Vugranam C. Sreedhar, Yorktown Heights, NY (US); Shun Xiang Yang, Beijing (CN); Yu Zhang, Beijing (CN)

(72) Inventors: Peng Ji, Beijing (CN); Lin Luo, Beijing (CN); Vugranam C. Sreedhar, Yorktown Heights, NY (US); Shun Xiang Yang, Beijing (CN); Yu Zhang, Beijing (CN)

(73) Assignee: INTERNATIONAL BUSINESS MACHINES CORPORATION, Armonk, NY (US)

(21) Appl. No.: 13/182,724

(22) Filed: Jul. 14, 2011

(51) Int. Cl. G06F 21/20

(52) U.S. Cl. 726/25

(57) ABSTRACT

A plurality of templates for web application server firewall rules are generated. A vulnerability report for the web application is obtained. At least one web application server firewall rule is generated, using the vulnerability report and at least one of the plurality of templates. The at least one web application server firewall rule is tested. The at least one web application server firewall rule is deployed to run on the web application server firewall.

### FIELD OF THE INVENTION

The present invention relates to the electrical, electronic and computer arts, and, more particularly, to web infrastructures and the like.

### BACKGROUND OF THE INVENTION

Virtual patching is a technique for temporarily fixing bugs and vulnerabilities in a software application without modifying the application. One aspect of virtual patching is the prevention of inputs that trigger the vulnerability from reaching the application so that a buggy or vulnerable path in the application is never executed.

### SUMMARY OF THE INVENTION

Principles of the invention provide techniques for interactive virtual patching using a web application server firewall. In one aspect, an exemplary method for interactive virtual patching of a web application includes the steps of generating a plurality of templates for web application server firewall rules; obtaining a vulnerability report for the web application; generating at least one web application server firewall rule, using the vulnerability report and at least one of the plurality of templates; testing the at least one web application server firewall rule; and deploying the at least one web application server firewall rule to run on the web application server firewall.

In another aspect, an exemplary method for interactive virtual patching of a web application includes the steps of generating a plurality of templates for web application server firewall rules; obtaining a vulnerability report for the web application; generating at least one web application server firewall rule, using the vulnerability report and at least one of the plurality of templates; testing the at least one web application server firewall rule; and providing a system. The system includes distinct software modules, each of the distinct software modules being embodied on a computer-readable storage medium. The distinct software modules include a rule development tool module and a runtime engine module. The generating of the plurality of templates is carried out by the rule development tool module executing on at least one hardware processor; the generating of the at least one web application server firewall rule is carried out by the rule development tool module executing on the at least one hardware processor; and the testing of the at least one web application server firewall rule is carried out by the runtime engine module executing on the at least one hardware processor.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:
enhance security protection against vulnerabilities in applications without any changes of applications' own code
better align application logic when perform patching

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an exemplary web application security protection architecture in a cloud environment, according to an aspect of the invention;

FIG. 5 depicts an exemplary HTTP request, according to an aspect of the invention;

FIG. 6 depicts an exemplary HTTP message model, according to an aspect of the invention;

FIG. 7 presents an exemplary JSON representation of an HTTP request model, according to an aspect of the invention;

FIG. 8 presents an exemplary rule model in a rule development tool, according to an aspect of the invention;

FIG. 9 presents an exemplary rule binding onto HTTP message and set rule inheritance in a rule development tool, according to an aspect of the invention;

FIG. 10 shows an exemplary rule and rule set model, according to an aspect of the invention;

FIG. 11 shows an exemplary JSON representation for a URI template and hierarchy on URL, according to an aspect of the invention;

FIG. 12 presents an exemplary rule sample for ModSecurity, according to an aspect of the invention;

FIG. 13 presents performance evaluation results for different modules enabled in web application security protection, according to an aspect of the invention;

FIG. 14 presents an exemplary rule definition in Hierarchical Rule Schema (HRS) for the ModSecurity rules of FIG. 12, according to an aspect of the invention;

FIG. 15 is a table showing a comparison for a Tomcat & Filter, ModSecurity, and web application security protection, according to an aspect of the invention;

FIG. 16 is a table showing an experiment environment setting, according to an aspect of the invention;

FIG. 17 shows average response time versus enabling different modules, according to an aspect of the invention;

FIG. 18 shows maximum new connections versus enabling different modules, according to an aspect of the invention;

FIG. 19 shows the cumulative transaction completed ratio versus enabling different modules, according to an aspect of the invention;

FIG. 20 shows certain URLs and the like, according to an aspect of the invention;

FIG. 21 shows a flow chart of an exemplary method outline of Interactive Virtual Patching, according to an aspect of the invention;

FIG. 22 shows an exemplary HTML request message, according to an aspect of the invention;

FIG. 23 depicts exemplary Rule Generation Based on AppScan Report and Application Context Information, according to an aspect of the invention;

FIG. 24 depicts and exemplary WASP Monitoring Console for Violation Request and Response, according to an aspect of the invention;

FIG. 25 shows an example of context information as struts.xml, according to an aspect of the invention; and

FIG. 26 shows an exemplary JSON representation for WASP security rules, according to an aspect of the invention.

### DETAILED DESCRIPTION OF PREFERRED EMBODIMENTS

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

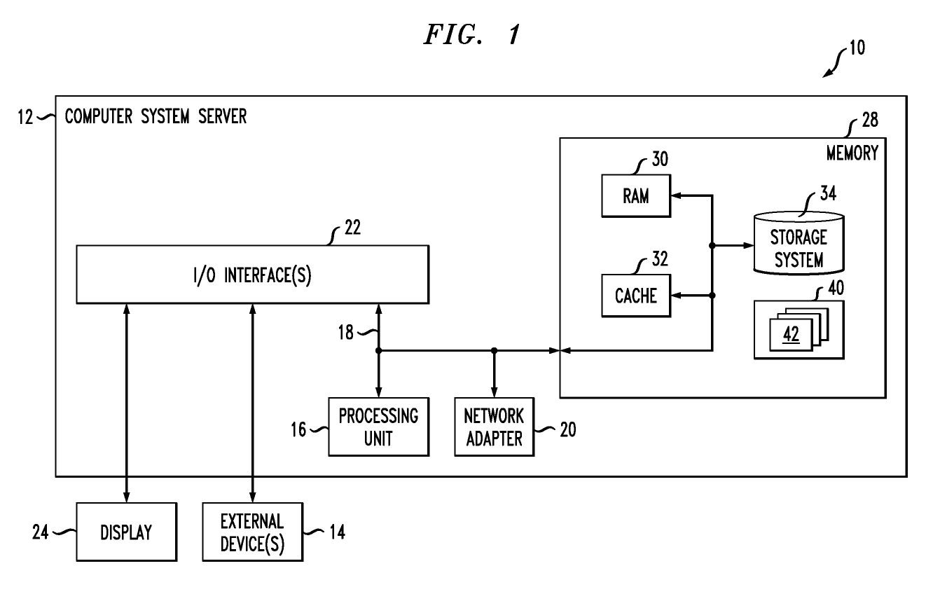

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

FIG. 1 is also generally representative of servers or other general purpose computers that can be used in connection with one or more embodiments of the invention in environments other than a cloud environment.

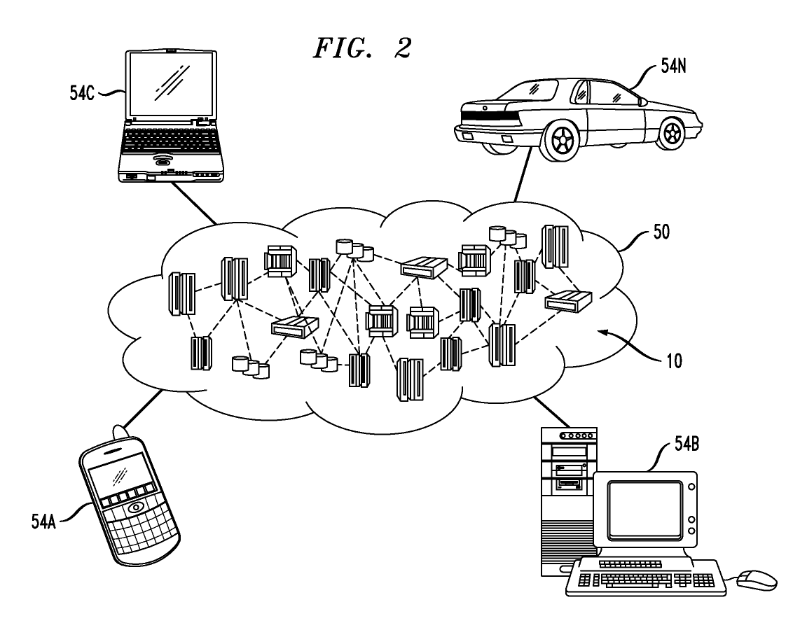

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community. Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

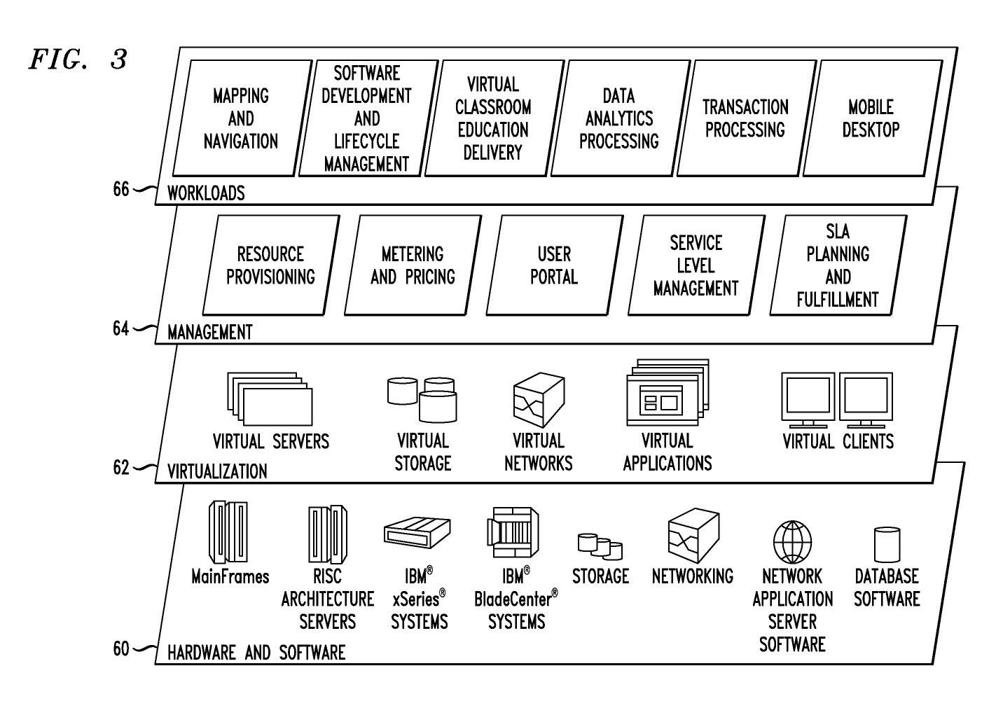

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WiebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

As noted, virtual patching is a technique for temporarily fixing bugs and vulnerabilities in a software application without modifying the application. A significant aspect of virtual patching is the prevention of inputs that trigger the vulnerability from reaching the application so that buggy or vulnerable paths in the application are never executed.

One or more embodiments provide a framework and a supporting development tool for Interactive Virtual Patching (IVP), which can be used to temporarily fix vulnerable Web applications. One or more non-limiting embodiments implement an IVP framework and the supporting development tool in a Web Application Security Protector (WASP). WASP is a Web application server firewall (WASP) with support for developing hierarchical fine-grain rules that can be used to filter inbound and outbound suspicious and malicious messages. Using the IVP framework, it is possible to semi-automatically derive filtering rules by scanning Web applications using a black-box vulnerability scanning tool. One or more embodiments include the IVP framework and the supporting development tool integrated with the software-as-a-service development process. Non-limiting exemplary experimental results demonstrate the capabilities of one or more embodiments of the IVP framework.

Note that WASP is a non-limiting example of a web application firewall; such firewalls per se are known to the skilled artisan and given the teachings herein, the skilled artisan will be able to implement aspects of the invention in one or more web application firewalls.

Consider the case of an application developer or a security administrator who has just deployed a new version of an application on a Web server. Assume that such person runs an application vulnerability scanning tool, such as the IBM Rational AppScan Tool, available form International Business Machines Corporation, Armonk, N.Y., USA (hereinafter “IBM”), and found a vulnerability in the new version of the application. Unfortunately due to the software application release cycle such person may not be able to patch the application immediately and redeploy it. In such a situation, a firewall can be used and it is possible to write firewall rules to filter suspicious and malicious messages from ever reaching a vulnerable backend application. For Web applications, a Web Application Firewall (WAF) is used to filter suspicious and malicious HTTP (HyperText Transport Protocol) messages.

There are two kinds of WAF. The first is a Web server or Web proxy server firewall, such as ModSecurity, which is deployed as an (Apache) Web server module. The second is a web application server firewall (WASF). A Web Application Server Firewall (WASF) is a firewall that is deployed inside a Web Application Server, such as a Tomcat server (available from the Apache software foundation) or WebSphere Application Server (WAS) (available from IBM), to filter unwanted messages and protect Web applications running on the server. Unlike a Web server application firewall, a WASF can exploit the semantics of the Web applications, including application layouts, to develop a richer collection of fine-grain rules.

One or more embodiments herein provide design and implementation of a fine-grain and hierarchical rule development for a WASF. There are two parts to hierarchical rule development: (1) hierarchical rule schema that naturally handles URL (Uniform Resource Locator) templates and RESTful (“REST”=representational state transfer; a RESTful web service (or RESTful web API is a simple web service implemented using HTTP and the techniques of REST)) requests, and (2) late binding of rules with message types that allows one to develop rules independent of messages and bind them to message sections as and when required. A rule includes two parts: condition and actions. A rule can be fired only if it is bound to some message section and its condition is true. The hierarchical rule schema (HRS) also supports forward chaining of rules and other features that allow an application developer or security administrator to develop rich and powerful collections of WASP filtering rules. One or more embodiments also support, in WASP, both position (allow) and negative (block) security models, along with rewriting of inbound and outbound messages. Rules in WASP are stored using JSON (JavaScript Object Notation) and managed using WINK RESTful services. For addressing cross-site scripting (XSS) vulnerabilities, WASP also supports a rich collection of filtering rules for handling HTML (HyperText Markup Language), XML (eXtensible Markup Language), and JSON message formats.

One or more embodiments provide a framework and a methodology for interactive virtual patching (IVP) along with a supporting rule development tool (RDT) implemented, for example, in WASP. Virtual patching is a patching process in which a security administrator or an application developer will develop and deploy one or more rules on a WASF to prevent any exploitation of application vulnerability in a released Web application product. In virtual patching, the back-end application code is not modified or sometimes not even re-configured. One difficulty that most security administrators face is how to go about developing firewall rules. One or more embodiments provide an interactive virtual patching process using RDT that semi-automatically allows a security administrator or an application developer to develop filter rules. One or more embodiments include a method with the following steps:
1. Generate templates for WASP rules using WASP rule schema and application context information.
2. Generate a vulnerability report using a black-box testing tool such as the IBM Rational AppScan testing tool.
3. Generate WASP rules using rule templates and the AppScan vulnerability report.
4. Test and deploy the rules to run on the WASP engine.

An application developer can repeat the above steps until he or she is satisfied with the generator filtering rules. In one or more embodiments, an RDT provides several capabilities that can help the application developer to quickly develop rules. Each of the above steps is described in detail below, and IVP capabilities are demonstrated in the context of a software-as-a-service development process. One or more non-limiting exemplary embodiments integrate the VP framework in the LotusLive Labs development process and the IVP methodology has been validated for one or more embodiments as indicated by non-limiting experimental results.

It should be noted that virtual patching is not a substitute for secure coding, but rather, it augments the secure software process to prevent exploitation when software has to be released on an expedited schedule or has already been released. In Software as a Service and Cloud environments where multiple applications are hosted, it is believed that virtual patching will become quite important. Virtual patching will bring added security, especially for patching third party applications. One or more embodiments provide techniques to semi-automatically generate and provision rules using application context and black box testing tool results, and to develop a method for interactive virtual patching (IVP) as part of the development life cycle. One or more instances collect the application context information such as web.xml, struts.xml or annotation information, and then use such information to generate the RESTful URI template.

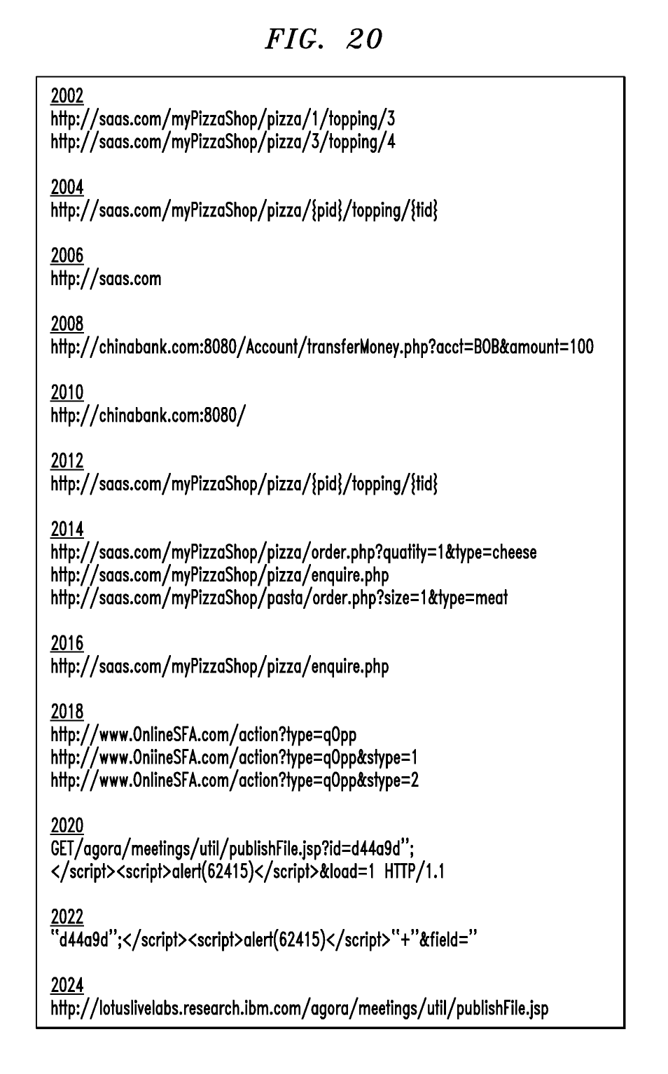

To illustrate an example of virtual patching, consider, at 2020 in FIG. 20, the snippet of an AppScan scan tool that injected the HTTP request message to be processed by a back-end application. The AppScan tool will intercept the response from the back end application and will observe that the snippet at 2022 in the response message indicates that the input was not validated, and so the vulnerability can be exploited to launch an XSS attack.

Using the IVP, the security administrator can quickly develop a rule to prevent such input validation vulnerability and thereby prevent zero-day XSS attacks. A significant aspect of the IVP is the tooling support that a security administrator can use to quickly develop rules to prevent vulnerability. Using the Rule Development Tool (RDT) a security administrator can import application context for URL templates, run the AppScan Tool, search for rules that prevent similar vulnerability, test the rule, extend and improve the rules, and then deploy the rule for real time monitoring. The whole process of scanning, rule development, and testing is interactive and can be part of an application development life cycle.

To improve the usability of developing and deploying firewall rules, one or more embodiments provide a Rule Development Tool (RDT) that provides several capabilities for developing and deploying rules, searching for similar rules, analyzing conflicts among rules, transforming rules from one format to another one, and interactive virtual patching. One or more embodiments of WASF are suitable for deployment in products and in a cloud environment.

As noted above, in a typical Web application a client, such as a browser, interacts with a Web server by exchanging a series of messages that are made up of hypertext transfer protocol (HTTP) requests and responses. An attacker often exploits vulnerabilities that exist in a Web application to launch attacks. Some of the predominant types of attacks against Web applications include Cross-Site Scripting (XSS), SQL Injection (SQL-I), and Cross-Site Request Forgery (CSRF) attacks.

A Web Application Server Firewall (WASF) is a piece of software installed inside a Web Application Server (WAS), such as a WebSphere® Application Server (registered mark of International Business Machines Corporation, Armonk, N.Y., USA (hereinafter IBM)) or a Tomcat server, to filter inbound and outbound Web content of the WAS using filter or firewall rules. Unlike a typical network or proxy server firewall, a WASF can exploit the richer semantics of the underlying Web applications to provide fine-grain protection of the Web applications running on the server.

A significant aspect in WASF is how and at what level of Web application semantics can be exploited without modifying the Web application itself. Imagine that a Web application developer has released a Web application, but has found vulnerability in the application. Unfortunately due to the release cycle, the developer cannot modify the application. One significant question is whether WASF can be used to provide fine-grain protection of the vulnerable application without any loss of functionality of the application. Modern Web applications that are based on AJAX (asynchronous JavaScript and XML) and REST contain rich content, services and hierarchical resources. A skillful attacker can launch sophisticated attacks targeting specific vulnerable resources and services. Coarse-grain firewall protection can often filter such attacks, but it can also prevent rich functionality provided by the underlying applications.

One or more embodiments provide fine-grain hierarchical rule development for a WASF, referred to herein as Web Application Security Protection (WASP), to address the problem of fine-grain protection of Web applications without modifying the vulnerable application and preventing loss of functionality. One exemplary solution includes two significant parts: (1) a Hierarchical Rule Schema (HRS) for writing flexible, fine-grained, and hierarchical firewall rules, and (2) a Rule Development Tool (RDT) to quickly develop rules to protect against zero-day attacks. The RDT provides several capabilities to the application developer and security administrator to develop, including searching for similar rules, parsing and modeling Web application configurations which often contain the application layout, integration with a black-box testing tool such as AppScan (available from IBM), transforming rules from ModSecurity (well-known open source web application firewall) to the HRS, and the like.

In one or more embodiments, the HRS is based on two design principles: (1) ability to support fine-grain rules to protect hierarchical Web resources and services and (2) late binding of rules to message types. A typical Web applications based on AJAX and REST maintains a large collection of hierarchical resources and services. A fine-grain hierarchical rule schema is necessary for effectively handling RESTful requests. Consider the example 2002 in FIG. 20.

A RESTful Web application that processes the GET requests for the URLs 2002 will typically not create one static page for each resource. The Web application will construct a layout for the URLs using a URI Template mechanism, described using configuration files or annotations. A URI Template is a mechanism that allows one to specify a URL to include parameters that is substituted before the URL is resolved. Using a URI Template mechanism an application can create the template 2004 for the example 2002, where {pid} and {tid} are resource variables that map to 1 and 3, respectively for the first URL (and will map to 3 and 4, respectively for the second URL). To handle such URI template-based HTTP requests requires the ability to model hierarchical rules and also an understanding of the back-end application structure. Using RDT, one or more embodiments parse and explore the configuration files and deployment descriptor of a back-end application and model the underlying hierarchical application structure.

One or more embodiments, using hierarchical rule language, model the above URI Template, obtained by parsing configuration files, as at 2006, which represents the instance of Hostname. Pizza {pid}, topping, and {tid} are instances of FilePathNode. For resources {pid} and {uid} also set the attribute is Variable to be true and the variableExpression is set ̂[0-9]+$ indicating that it matches numerical value pattern. Another point is to set the attribute inheritParent to the node tid, which means the rule bound to the parent node such as topping will be inherited and applied to the child node. The above URI Template is then represented using JSON (JavaScript Object Notation). JSON is a simple and flexible language that is used in one or more embodiments for representing not only core elements of the rule language; meta-information about various parts of the rule elements that provide additional capabilities can also be expressed.

The HRS allows late binding of rules with message components on which the rules operate. To further elaborate the late binding principle, consider a typical HTTP GET request. It includes several components, such as headers, URL, cookies, and the like. One or more rules can be bound to each of these components. A rule includes two parts: condition and action. A rule typically has to be bound to a message before it can be triggered. In other words, an unbounded rule can typically never be triggered, even if its condition is true always. Now, when a condition of a bounded rule is true, then the corresponding action is executed. Using RDT a security administrator can develop new rules, and bind existing rules to different components of a message. Late binding provides flexibility, wherein a security administrator can decide how the rules are bound to messages.

A non-limiting exemplary embodiment implements WASP using a J2EE (JAVA enterprise edition) framework and so the exemplary WASP can potentially be deployed inside any J2EE Web application server. In non-limiting experiments, WASP has been integrated into WebSphere application server (WAS) and Tomcat server and has also been deployed in a Cloud environment. Several empirical results that highlight different features of WASP, including results that compare and contrast WASP with ModSecurity and various performance results, are presented herein.

### Exemplary WASP Design

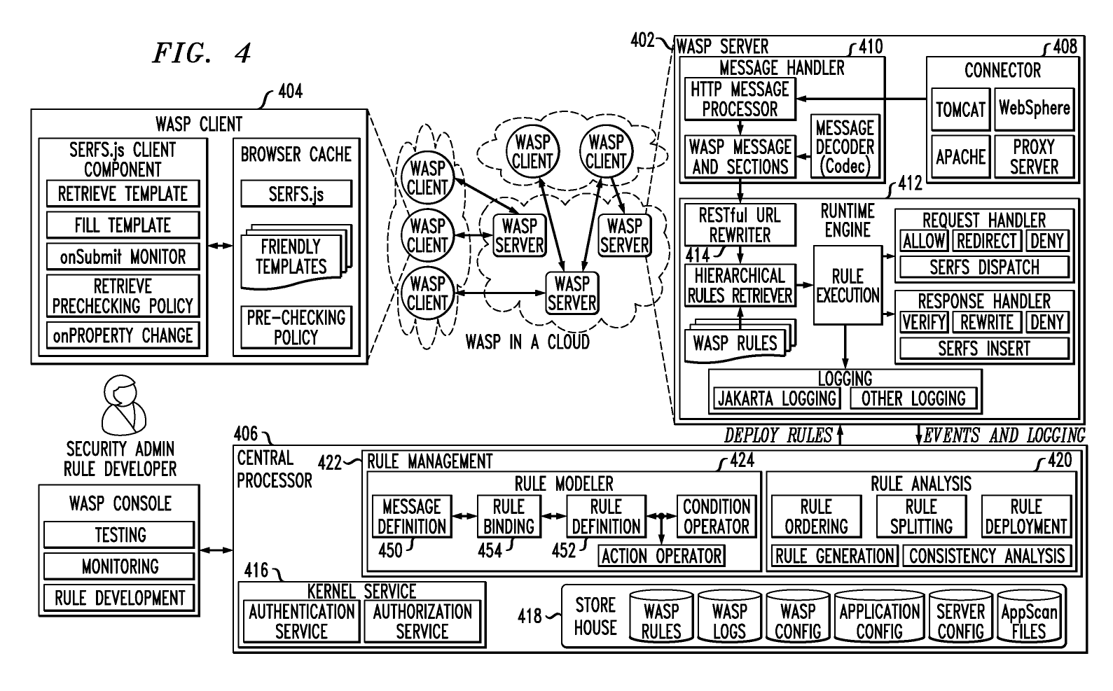

The exemplary design of WASP provides a flexible WASF for new enterprise models such as the Cloud environment. FIG. 4 shows the overall system architecture of WASP. The exemplary WASP embodiment includes WASP Server 402, WASP Client 404, and WASP Central Processor 406.

WASP Server

The WASP Server 402 processes HTTP request and response messages and applies rules to filter bad messages and allow good messages. The basic filtering process includes first intercepting the HTTP request/response messages, constructing WASP internal message objects based on a message model (as described in below), and applying filtering rules deployed inside the engine. The WASP Server shown in FIG. 4 in turn includes a connector 408 which essentially captures the HTTP requests and responses, and then forwards them to the message handler 410. A non-limiting exemplary embodiment supports Tomcat server and WebSphere Application Server (not separately numbered in block 408). In some cases, WASP can be employed in IBM WebSphere proxy server and Apache server, and in these deployments can be used as a proxy firewall that does not exploit the richer application semantics. One or more embodiments do not modify the original messages, but instead create a copy of the message and forward to the Message Handler 410.

The Message Handler 410 parses the messages forwarded by the Connector and creates the WASP message object (described in detail elsewhere herein). For each request/response message, multiple sections will be created based on the HTTP message protocol, including the Header Section, Cookie Section, Query String Section, Body Section, and so on. Some encoded characters, such as base64 value, Hex value, and so on, still can launch the XSS attack especially when these characters are embedded in a requested URL as the query string. Thus, the decoder module is used to sanitize the input values if it contains different encoding characters.

The Runtime Engine 412 is a significant module that processes the request/response based on the security rules. The RESTful rewriting module 414 is used to support RESTful URL and URI templates. To obtain the context of the RESTful requests, one or more embodiments import and analyze the application configuration files such as web.xml, application.xml, and the like, to create the regex (regular expression) pattern for the RESTful URLs and URI templates. Then, based on the URL regex pattern, map the dynamic RESTful URL to the common static one, then index the rules based on the common static one. In this manner, there is no need to create the security rules for each dynamic URL which has the same URL pattern, so that the rule configuration cost can be reduced. After indexing the rules based on the request URL pattern, process each section in the request/response message based on the security rules. If one rule is triggered, the corresponding actions defined in the rule will be enabled, such as denying the request, logging, responding with a friendly error message, and so on.

WASP Client

One salient feature of WASP is that in the new enterprise model client side applications are considered as part of the enterprise model. WASP Client provides a number of capabilities, such as user friendly error report when requests are blocked, client pre-checking of rules, and the like.

WASP Central Processor

The WASP Central Processor 406 is where offline analysis, rule development, rule testing, and rule deployment are performed. The Central Processor includes Kernel Services 416, Store House 418, Analysis Engine 420 and Rule Management 422.

Kernel Services:

A Cloud environment will typically host many different kinds of application services with different security requirements. The Kernel Services 416 provide user-centric access to WASP internals so that firewall rules and other log information for one application is not exposed to users of another application.

Store House:

In one or more embodiments, the Store House 418 stores all of the relevant information, including rules, analysis results, abstraction of application configuration, and so on. One or more embodiments store most of the information as resources using JSON and/or XML (extensible markup language), and provide a RESTful API (application program interface) to access and update the resources. Some embodiments use APACHE WINK as the RESTful framework. As an example, a rule can be obtained with the specified ID as /rule/{ruleID}, or get all the rules in the ruleset with the specified ruleset ID as /ruleset/{rulesetID}/rules. Also for the rules binding to the different sections of the WASP message, the rules can be obtained from the interface as /message/{messageID}/section/rules. The interface /message/95601/header/rules means it can get all the rules that are bound to the header section in the message with the message ID 95601.

Rule Management:

Rule Management 422 includes the Rule Modeler module 424 and Rule Analysis module 420. The Rule Modeler 424 is used to model the HRS, including the message model and rule model, which is discussed further below.

### Hierarchical Rule Schema

WASP is a state-of-the-art WASF that is designed for deployment in a Cloud environment. The Hierarchical Rule Schema (HRS) of WASP is described below. One or more embodiments use JSON (JavaScript Object Notation) as the underlying representation for rules. One or more embodiments also support an XML schema representation. In one or more embodiments, the HRS includes three parts: (1) an HTTP Message Model that defines the core model of the HTTP message structure, (2) a Rule Model that can be used for writing firewall rules, and (3) Message Rule Binding which is appropriate to determine the set of rules that should be triggered at runtime for a given message.

### HTTP Message Model

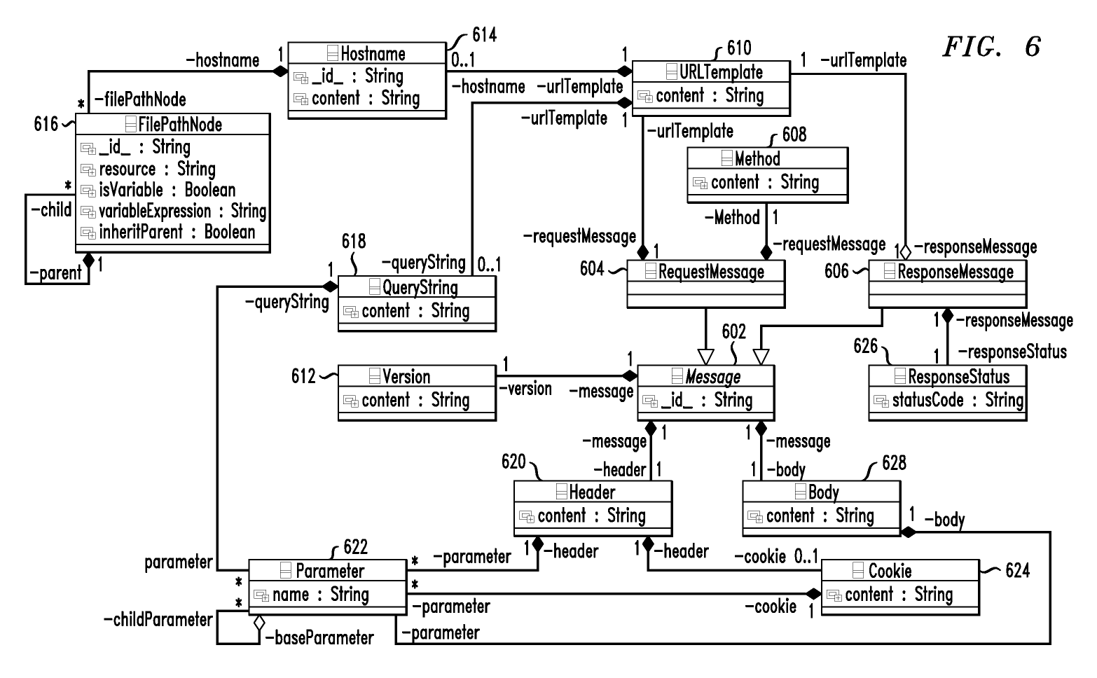

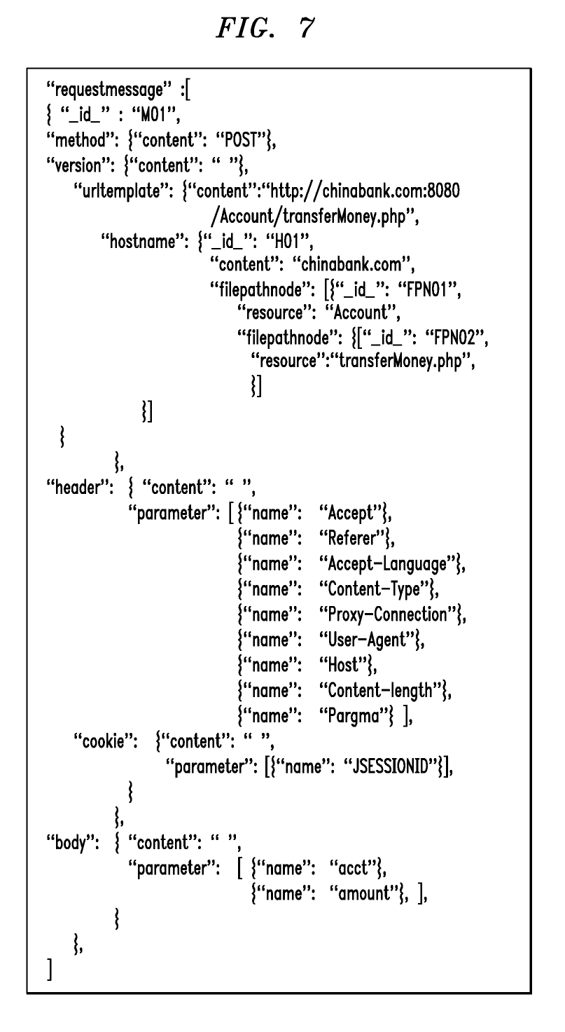

One or more embodiments model the HTTP request and response messages using structured WASP message objects that represent various parts of an HTTP message. FIG. 6 illustrates the message model using UML (Unified Modeling Language). The HTTP message model captures relationships among various elements and at runtime the representation is used to bind rules to message elements. The example in FIG. 7 illustrates a JSON representation of an HTTP message model instance.

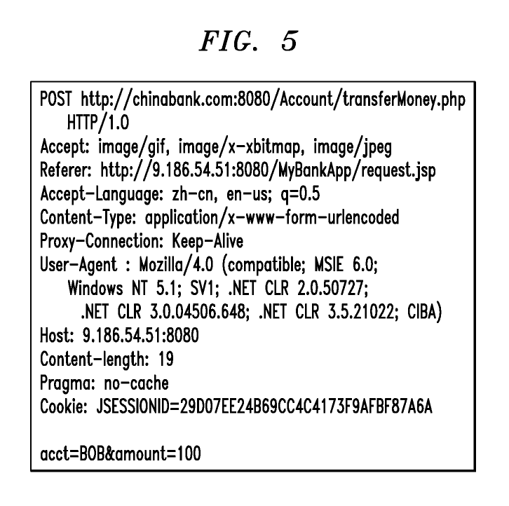

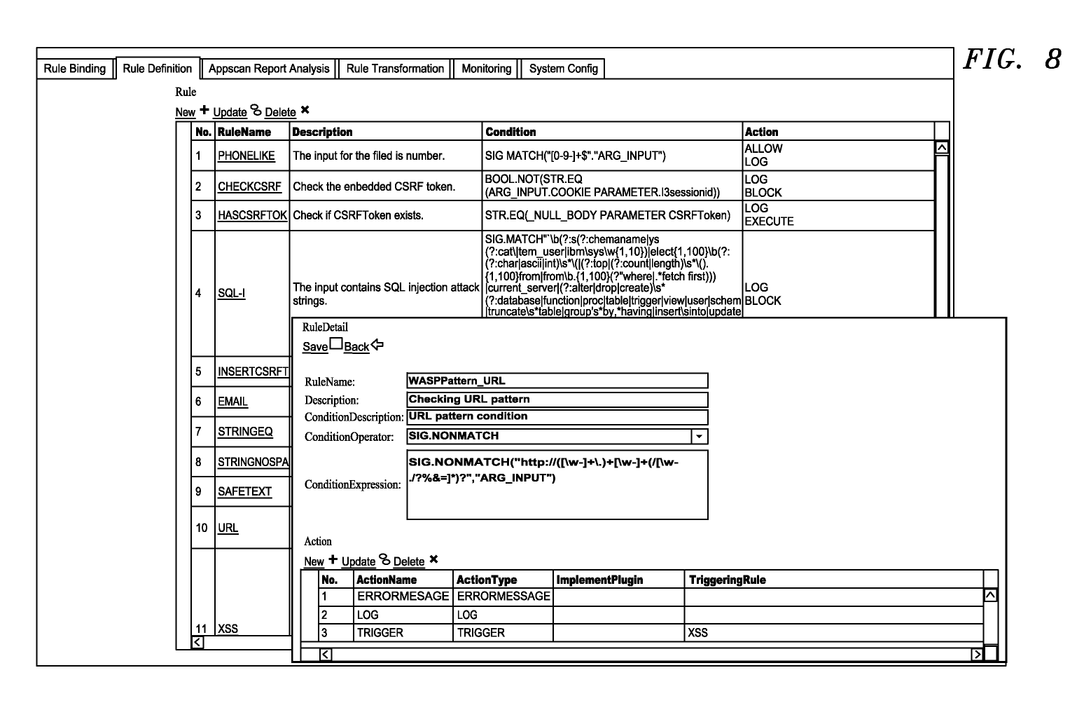

Rather than developing a new surface syntax to express rules, in one or more embodiments, WASP uses JSON (JavaScript Object Notation) as the underlying representation for rules. (One or more embodiments also support XML schema representation.) The HRS includes: (1) HTTP Message Model as seen in FIG. 6 that defines the core model of the HTTP message structure, (2) Rule Model of FIG. 8 that can be used for writing firewall rules, and (3) Message Rule Binding of FIG. 7 which is desirable to determine the set of rules that should be triggered at runtime for a given message. In one or more embodiments, the basic format of HTTP request and response messages includes (1) the initial line, (2) a sequence of header lines, (3) a new blank line, and (4) the body. The initial line for a request message typically contains one of the HTTP methods (such as GET, POST, HEAD, and the like). The initial line for a response message typically contains status information that includes status code. FIG. 5 illustrates an example of a POST request.

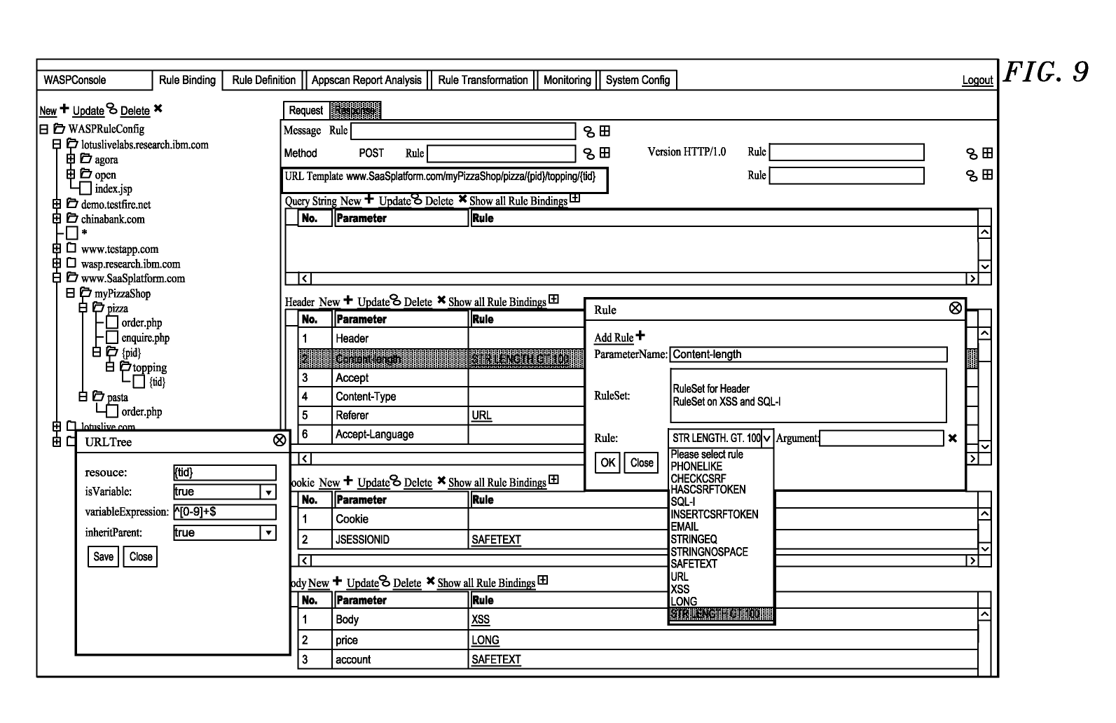

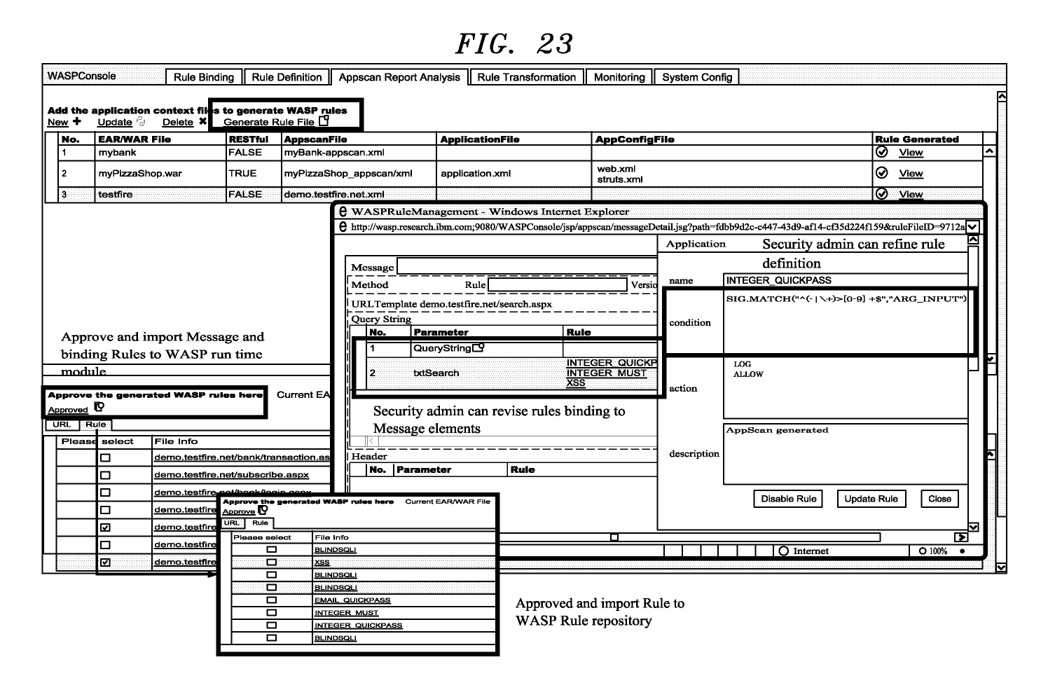

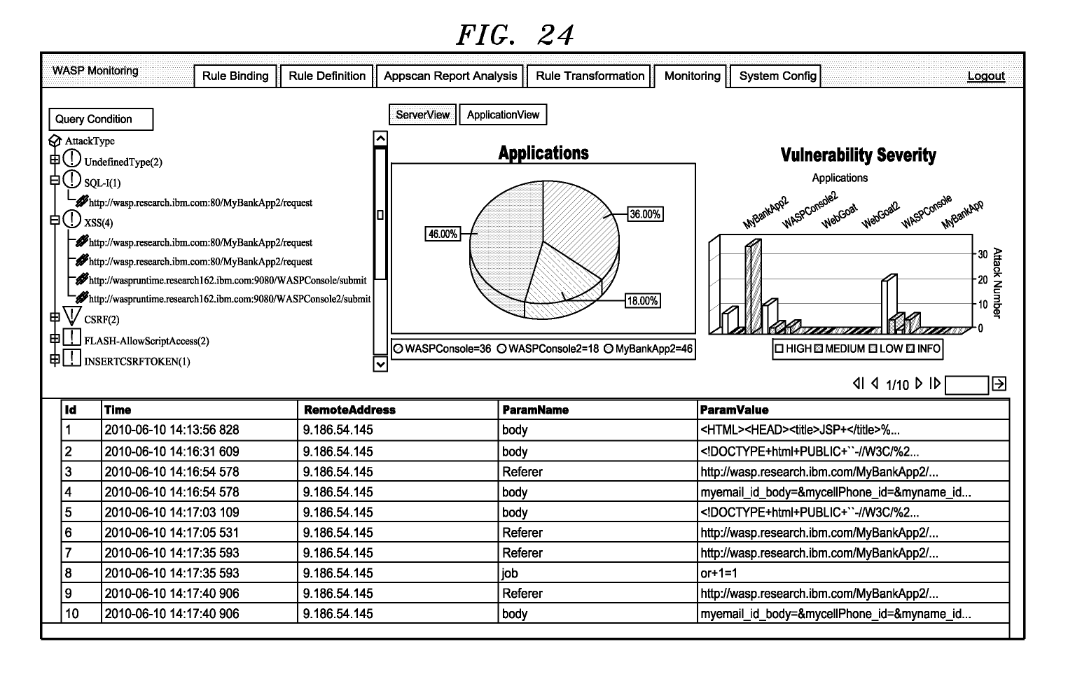

It is worth noting at this point that FIGS. 8, 9, 23, and 24 are pages from an exemplary web application (the WASP console of FIG. 4). This application can be implemented, for example, in JSP, Java, Servlet and HTML. FIG. 8 shows exemplary detailed definition of one rule. FIG. 9 shows rule binding; the right block indicates how to bind rules or rulesets onto http message sections, while the left block shows the hierarchy structure in URL (i.e., who is the parent FilePathNode, and whether inherit rules from parent). FIG. 23 shows how to generate a rule from an appscan report or the like (a significant aspect of IVP in one or more embodiments). Included are the details of generated rule candidate, the candidate list for rule review, and the like. FIG. 24 is a monitoring page on what threats the WASP, based on rules, has discovered, and the result is to be shown in graphs.

The overall HTTP message model using UML (Unified Modeling Language) is shown in FIG. 6. The root of the HTTP message model is the abstract element called Message 602. The RequestMessage and ResponseMessage 604, 606 are concrete types of Message element, and they correspond to HTTP request and HTTP response messages. Recall that the initial line of an HTTP request contains method, URL, and version; these are represented as Method, URLTemplate and Version elements 608, 610, 612. The Version element is used to represent HTTP version number in both HTTP request and response and so it is part of in the Message element (denoted using solid diamond symbol). A Method element can be one of GET, POST, PUT, DELETE, and HEAD. The URLTemplate element is split into HostName element 614, a sequence of FilePathNode elements 616 and a QueryString element 618. Notice that URLTemplate is part of RequestMessage (denoted by solid diamond symbol), whereas URLTemplate is referenced by ResponseMessage (denoted by plain diamond symbol). The distinction is appropriate for indexing rules when response messages are processed.

Recall that each HTTP request and response includes a header section, and this can be modeled using the Header element 620. The Header element can be considered to be a set of name-value pair represented as a set of Parameter elements 622. Notice that in the model cookies are modeled using the Cookie element 624; and the reason for this is that they typically contain significant elements (such as session information and authentication information) that are needed for writing filtering rules against cookies. Once again a Cookie element includes a set of name-value pairs and so they are modeled as a set of Parameter elements. The QueryString element, which is part of the URLTemplate element, is also modeled as a set of name-value Parameter elements. Finally, when the value of the Content-Type, defined in the HTTP request header, is application/x-www-form-urlencoded, the message body will also be name-value pairs, and therefore they are modeled as a set of Parameter elements. In an exemplary WRS different types are handled for the body. The Content-Type element defines the content type of the body. Unlike the RequestMessage element, the ResponseMessage element includes a ResponseStatus element 626. The statusCode attribute can be any of the status code as defined by the well-known IETF HTTP protocol standard. The ResponseMessage element also includes Header element, Version element, and Body element 628.

Consider the URL elements of an HTTP request, which can be modeled as a URLTemplate element. As shown in FIG. 6, each URLTemplate element 610 includes three parts: (1) Hostname element 614, (2) sequence of FilePathNode elements 616, and (3) QueryString element 618. The QueryString includes Parameter element 622 that represents the name-value pairs. Now consider the HTTP request URL 2008. Element 2010 is an instance of the Hostname element. The resources Account and transferMoney.php are instances of the FilePathNode element. Finally, acct=BOB&amount=100 is an instance of QueryString. Notice that QueryString includes two name-value pair of Parameter elements separated by &: acct=BOB and amount=100.

Each FilePathNode includes several attributes such as is Variable, variableExpression, and inheritParent, explained below. To summarize, in one or more embodiments, the HTTP message model is concise and is semantically rich for developing rule models. The example in FIG. 7 illustrates a JSON representation of an HTTP message model instance for the example shown in FIG. 5.

Rule Model

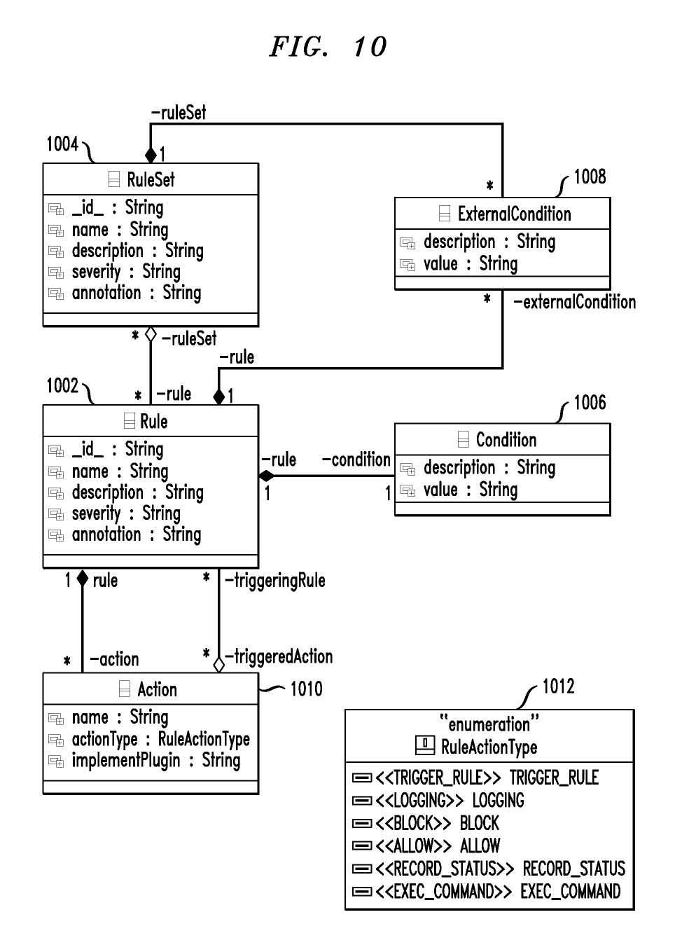

FIG. 10 shows the UML class diagram for the HRS rule model. A security administrator uses RDT for developing rules and also for performing other kinds of activities. FIG. 8 shows a screen-shot of rule development using RDT. In one or more embodiments, there are three significant parts in the rule model. The first part includes Rule and RuleSet elements 1002, 1004; the second part includes Condition and ExternalCondition elements 1006, 1008; and the last part includes the Action element 1010.

Rule and RuleSet Element:

The basic structure of a rule will look like:

R01: if condition then action.

Whenever the condition holds true the corresponding action is executed. The following is an example of a rule R01:

if (NUM.GT(STR.Length(Request.Header.Parameter[Content-
Length]), 100)) then Action.Log.

In the above rule, Request.Header.Parameter[Content-Length] identifies a particular header parameter and a check is made whether its string length is greater than 100. Notice the way the HTTP message model elements are accessed. Recall from FIG. 6 that Parameter is a name-value type of model element and Content-Length is the name and the notation Parameter[Content-Length] returns its value. An instance of a Rule element typically has three main parts: (1) a Rule identifier that identifies the rule, such as R01, (2) a Condition such as NUM.GT(STR.Length (Request.Header. Parameter[Content-Length]), 100) and (3) Action, such as Action.Log. In one or more embodiments, the WASP rule schema contains several pieces of meta-information, such as name, _id_, description, and the like; those are useful for writing rules, and JSON is used to write rules. One or more embodiments group together a set of rules that have some common purpose using RuleSet elements.

Condition and Action Element:

One or more embodiments use the Condition element to model rule conditions. One or more instances support a number of different condition operators such as regex matching, numeric or string comparison. One or more cases use the Action element to model actions of a rule. A rule can trigger more than one action when the corresponding condition of the rule is satisfied. The attribute actionType is used to represent the action type. The action types such as Block, Allow, and Log are straightforward to understand. The Record(variable, value) is useful when the runtime engine wants to manage state across different rule executions, for instance, supposing it is desired to know if a particular rule R01 had fired previously. In this case, when rule R01 is fired its status will be recorded in a variable using Record(variable, value) action. The action type Execute(path) will execute an external command referenced by a fully qualified path. The action type Rewrite is useful to rewrite values of certain elements, such as rewriting the URL value. See generally block 1012.

Rule Binding

In this section two concepts are discussed; the first is hierarchical rule binding and the second is rule inheritance.

Rule Binding:

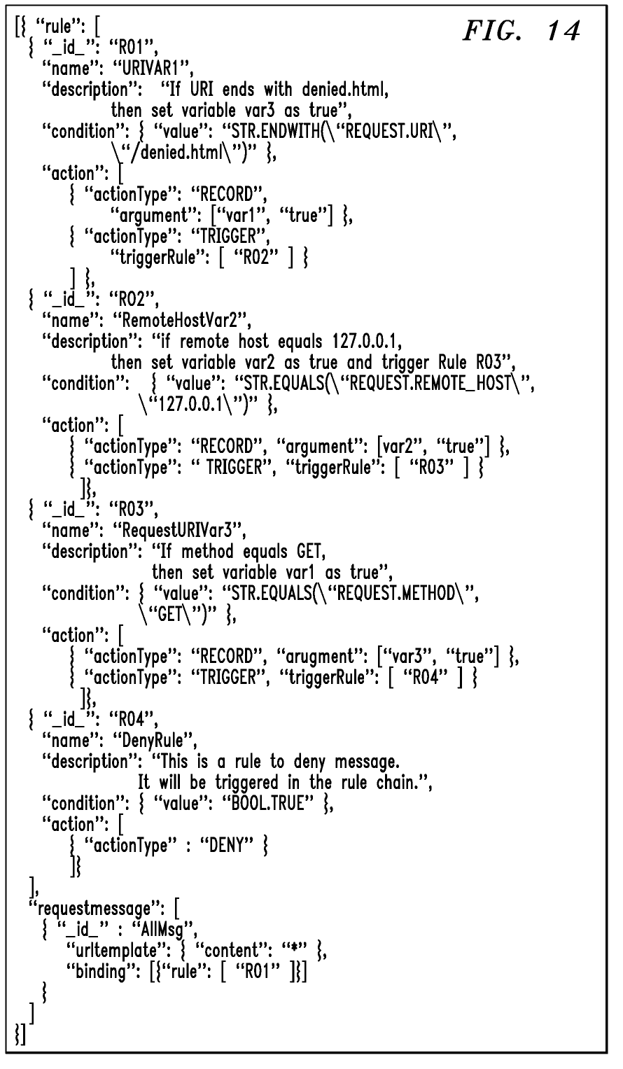

Based on the HTTP message model and the rule model, the next concept that is significant for a security administrator is to understand how to bind rules to HTTP messages. In one or more embodiments of WASP, a rule can triggered only if it is bound to some message element. In other words, unbounded rules can never be fired even if the condition of the rule is always true. A security administrator can use the RDT to bind rules to HTTP message models. FIG. 9 illustrates a screen-shot of rule binding using RDT (FIG. 14 illustrates binding using JSON format). The first step in the RDT is to create a new template based on the HTTP message model. The RDT will present the new template of the HTTP message model to a security administrator and the template will highlight all the elements of the HTTP message model. There are one or more entries for each element that can be filled in by the security administrator. For instance, for the URLTemplate element, the security administrator can fill in a URL that includes host name and file path nodes. The file path node could contain resource variables (such as pid, as discussed above). One or more embodiments use the URLTemplate instance as an index or key during runtime to retrieve the current HTTP model and/or template instance. For the Header element, one or more embodiments also create the set of headers that are allowable for the current HTTP model instance. Once the instances of all the elements of a new template are created, the security administrator can then bind or associate one or more rules to each element by either using a pre-existing set of rules or by developing new rules.

One or more embodiments of HRS use late binding of rules to message elements. A security administrator can, using RDT, bind existing rules or develop new rules and then bind them to message elements. The first step in the RDT is to create a new template based on an HTTP message model. The RDT will present the new template of the HTTP message model to a security administrator and the template will highlight all the elements of the HTTP message model. There are one or more entries for each element that can be filled in by the security administrator. For instance, assume that a Content-Length header element is created for the URL template instance 2012.

Assume that the following rule is associated:

If (NUM.GT(STR.Length(Header.Parameter[Content -Length]),
100)) then Action.Log.

At run time, retrieve the HTTP message template instance using the aforementioned URL as index and then fire all the rules that are bound to various element instances. It should be noted that normalization of the message contents are usually required to be implemented in the WASF engine before executing the rules.

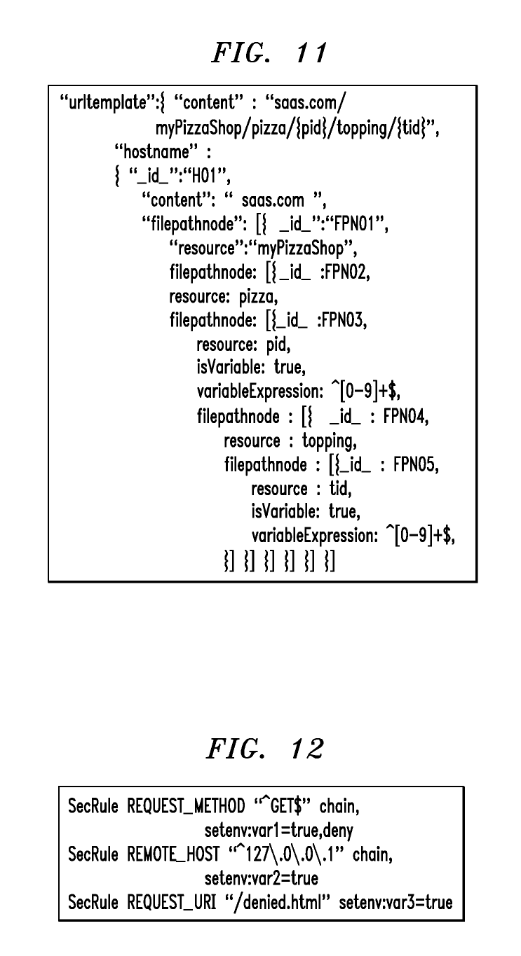

Web application developers often want the ability to express the layout of URLs that their application can respond to. To further elaborate, consider the URLs 2002 that a particular Web application will handle. The Web (REST) application that processes the GET requests for the URLs 2002 will typically not create one static page for each resource. The Web application will construct a layout for the URLs, and using URLTemplate the template can be created as at 2004, where {pid} and {tid} are resource variables. Model the above URLTemplate using the model as follows: URL 2006 represents the instance of Hostname, pizza, {pid}, topping, and {tid} are instances of FilePathNode. For resources {pid} and {uid}, also set the attribute is Variable to be true and the variableExpression is set to ̂[0-9]+$ indicating that it matches the numerical value pattern. The aforementioned URLTemplate can be represented using JSON as shown in FIG. 11.

Rule Inheritance:

Next consider how to inherit rules that are written for parent parts of the HTTP model. To understand the notion of parent, use a URL structure to build a URL tree model. The motivation for inheritance is that most Web applications have a hierarchical structure. For instance, the web.xml file, which contains the configuration of a Web application, describes a tree-like structure for a Web application. To illustrate this further consider the URLs 2014 that are part of a sequence of HTTP messages.

A security administrator can write a set of rules for the resource “pizza” and this set of rules could apply to all descendants of the pizza node in the above URLs. In other words both order.php and enquire.php can inherit this rule. Now, when an HTTP message with URL 2016 arrives, construct an instance of the HTTP message model. The run time will then use the URL to access the message model for enquire.php and if the inheritParent attribute is set to true for the file path node enquire.php, the rule bound to “pizza” will be inherited and applied to HTTP message model elements.

A second kind of rule inheritance that is supported in one or more embodiments is called the parameter inheritance. To further explain parameter inheritance, consider a Web application that provides the three related URLS 2018. The first of these URLs is the base URL that provide base query opportunity function. The second and third of these URLs with different stype provide two different techniques for a querying opportunity; say, stype=1 is a query by name and stype=2 is a query by time. From a business logic point of view the functions corresponding to the second and third of the URLs are subtype functions of the first URL. Thus, from a security point of view, the second and third URLs can inherit rules from the base URL. One or more embodiments model such rule inheritance for parameters by modeling parameters as a hierarchical structure.

### Rule Transformation and Chaining

One or more embodiments of WASP currently provide capabilities to transform rules from the ModSecurity format to HRS and also from HRS to the IBM DataPower firewall rule format. FIG. 14 shows the HRS for the ModSecurity security rules shown in FIG. 12. The rule chaining in HRS is more expressive than the linear chaining rule in ModSecurity. In HRS, one or more embodiments follow the classical forward chaining semantics, where one or more conditions that are shared between rules are considered to be chained. Rules are chained in a tree-like fashion using trigger action type. An action can contain more than one TRIGGER action. One or more embodiments share the conditions between chained rules, and therefore the same condition is evaluated once for all rules. The ModSecurity chain rule for disruptive actions, such as deny action, is restricted to the first rule in the chain, thereby creating unexpected side-effects. For instance, in ModSecurity a request will be denied only when all three rules in the chain trigger and all three non-disruptive actions that set variables will be executed. In one or more embodiments, the deny action is the last rule of the chain. In HRS all actions are performed as though they are standalone rules. This allows one to compose rules via chaining. One or more embodiments separate the deny rule R04 and its condition is set to true, as seen in FIG. 14. Recall that for a rule to be triggered it should also be bound to a message. For HRS rule chaining only the first rule in the chain R01 needs to be bound to a message part, such as content, and the rest of the rules in the chain are triggered as a consequence of the chaining.

### Interactive Virtual Patching (IVP)

Virtual patching is a process in which a security administrator or an application developer will develop and deploy one or more rules on a WASF to prevent any exploitation of application vulnerability in a released Web application product. Virtual patching is not a substitute for secure coding, but it augments the secure software process to prevent exploitation when software has to be released on an expedited basis or has already been released. In Software as a Service and Cloud environments where multiple applications are hosted, virtual patching will likely become quite significant. Virtual patching will bring added security, especially for patching third party applications. One or more embodiments allow provisioning of rules using application context and black-box testing tool results to develop a method for interactive virtual patching (IVP) as part of the development life cycle. In one or more embodiments, a method for IVP for provisioning rules includes the following steps.
Step 1: Generate templates for WASP rules using WASP rule schema and application context information.
Step 2: Generate a vulnerability report using the AppScan testing tool.
Step 3: Generate WASP rules using rule templates and an AppScan vulnerability report.
Step 4: Test and deploy the rules to run on the WASP engine.

### Template Generation

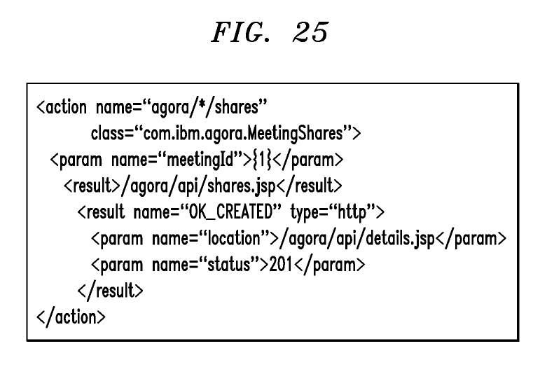

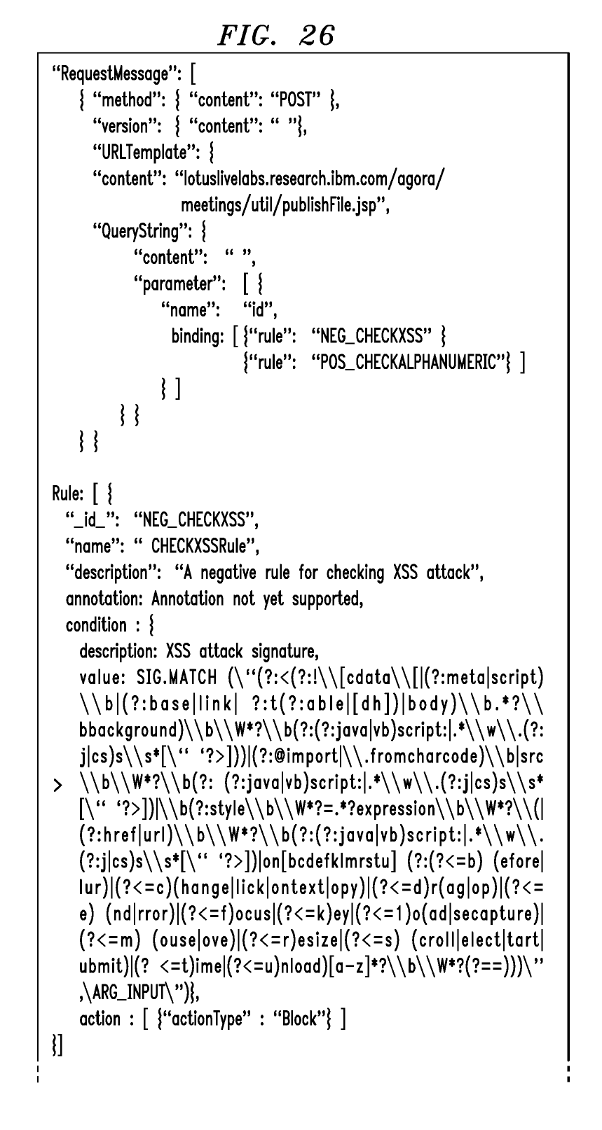

In one or more embodiments, the rule template generation uses two sources of information. A first of these is the WASP Rule Schema, which provides the relationship among the various HTTP elements as discussed elsewhere. A second of these is the context information such as web.xml, struts.xml (or expressed as application annotations), which provide the hierarchical structure of the Web application. Web application developers often want the ability to express the layout of URLs that their application can respond to. The layouts are often expressed in a configuration file in application package; for example, in FIG. 25, the Web application will construct a URLTemplate as:

/agora/{meetingId}/shares,

where {meetingId} is a resource variable.

### Black Box Testing and Analysis

IBM Rational AppScan is a non-limiting example of a robust Web application black-box security testing tool that can be used to scan applications for identifying vulnerabilities. AppScan has built in capabilities to scan and test a wide range of Web application vulnerabilities. One or more non-limiting exemplary embodiments integrate AppScan within the WASP framework so that a security administrator or application developer can configure and scan Web applications directly using the WASP framework. Information is provided herein regarding pertinent elements of the AppScan vulnerability report and how to analyze them for generating WASP rules. AppScan reports typically include two types of security issues:
The application security issue is mainly due to insecure code implementation. In one or more instances, WASP focuses mostly on application security issues.
The infrastructure security issue is mainly related to improper system configuration or system-level holes. It is believed appropriate to fix this kind of issue by changing the system configuration and updating the patches accordingly because it will not cost much time like revising application codes. When there are limitations to update the system configuration, WASP can still be utilized to patch the vulnerability.

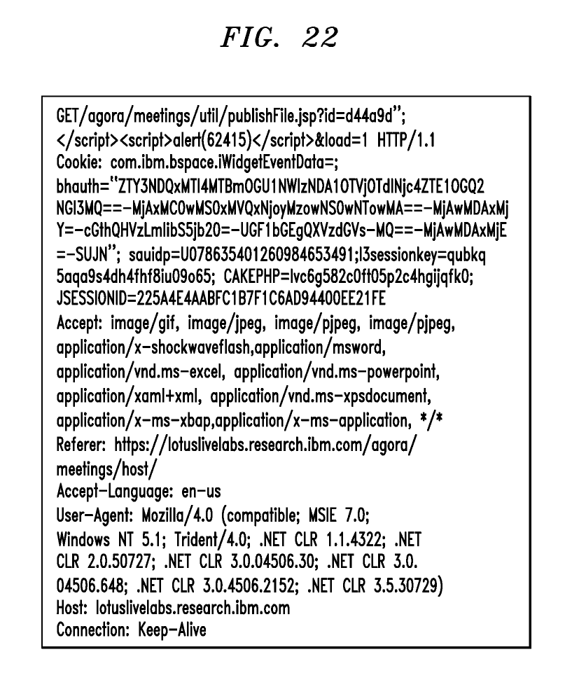

To illustrate the capability of WASP virtual patching, consider the vulnerable URL 2024. Looking at the URL it seems that it provides a utility to publish files. AppScan reported a possible Cross-Site Scripting (XSS) vulnerability for this URL. The AppScan scanning tool injected the HTTP request message in FIG. 22 to be processed by the Agora backend application.

Notice the Parameter:

id=d44a9d”;</script><script>alert(62415)</script>.

AppScan injected this script and later verified that the corresponding HTTP response contained the injected script. The App-Scan testing tool alerts such cases as being an XSS-vulnerable URL. WASP can be used to block such HTTP requests using virtual patch rules.

### Rule Generation

Recall the URLTemplate for the Rest applications can be obtained by generating the rule template in Step 1, which parses the web.xml, struts.xml, and so on. Second, parse the vulnerability issues in the AppScan XML report to create WASP rule instances based on WASP rule schema, and then merge the URLTemplate value to the rule instances. Because of false positive issues, the security administrator preferably approves the rules generated from the AppScan report as shown in FIG. 23, and then the rules are imported to the runtime WASP engine for further testing.

From the AppScan report, notice that the URL query parameter id is susceptible to XSS vulnerability. In WASP, either negative rules or positive rules can be used to handle XSS vulnerability. In order to explain better, only two rules are shown in FIG. 23 as a non-limiting example to show how to bind rules to the element.

### Testing and Deployment

In one or more embodiments, a security administrator can use the WASP Rule Development tool to develop rules and can then test them inside the WASP framework. The HTTP message generated by AppScan can be injected in the testing environment. The WASP runtime engine will process the requests and then generate log files that contain what rules were fired and what actions were taken. The WASP monitoring console for the violation logs is shown in FIG. 24. The security administrator can, if needed, refine the rules interactively until he or she is satisfied. Once the rules have been tested within the WASP test environment, they can be deployed for real time monitoring of HTTP requests and responses. Several testing techniques can be employed. For example, in some cases, carry out regular expression checking on rule content. In another approach, just deploy rule candidates into testing WASP and test whether they can block target attacks, if yes, they will be selected, otherwise, refinement is required.

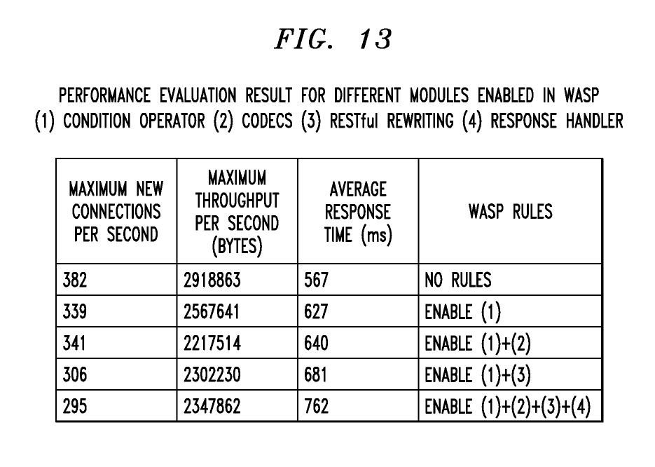

The table of FIG. 13 shows performance evaluation results for different modules enabled in WASP: (1) Condition operator; (2) Codecs; (3) RESTful rewriting; and (4) Response handler.

### Empirical Results

This section first compares the functionality for the Tomcat 7 filter, ModSecurity and WASP and then describes non-limiting exemplary experiences with WASP, focusing on performance evaluation and usability for user experience.

### Functionality Evaluation

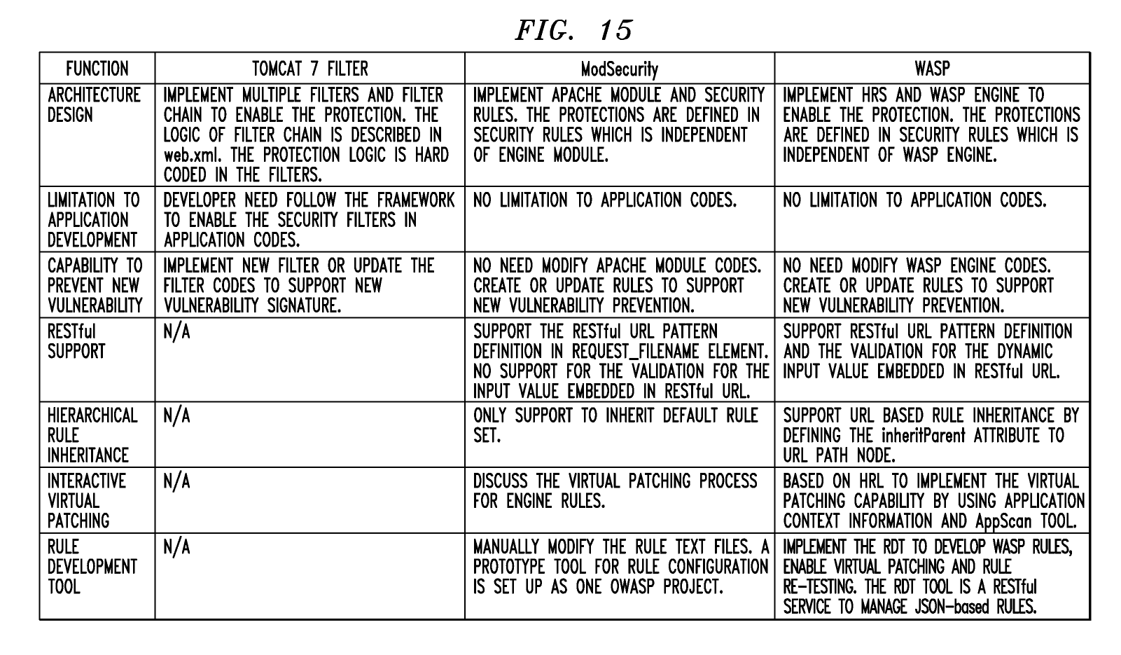

To evaluate the functionality of WASP, a comparison was made to compare WASP with two open source WAFs; one was the Tomcat 7 filter and the other was ModSecurity. First, the architecture design, the limitation for application codes development if enabling WASF functions, and the capability to prevent new vulnerability, were evaluated. As shown in the table of FIG. 15, it has been found that for WASP and ModSecurity, the rule definition is independent of the rule engine. It is possible to create or update the rules to prevent new vulnerabilities in WASP and ModSecurity, and the firewall function is transparent to the applications, meaning that no modification of application codes is needed. For the Tomcat 7 filter, the security protection is implemented as multiple filters, and the application developer needs to follow the framework to enable the security filters in application codes. No rules definition is enabled in the Tomcat 7 filter.

Second, evaluate the capability for the rules definition. Comparing to ModSecurity rules, a significant feature for WASP HRS is the ability to support the RESTFul URL pattern definition and the validation for the dynamic input values embedded in the RESTful URL. Meanwhile, HRS can support the URL-based rule inheritance by defining the inheritParent attribute to the URL path node.

Third, the virtual patching capability is implemented in WASP by using application context information and the AppScan tool. Then, it is possible to further re-test the rules using the RDT testing tool. The RDT is implemented as the RESTful service, which provides the RESTful API for users to manage JSON-based rule files in the WASP store house.

### Performance Evaluation

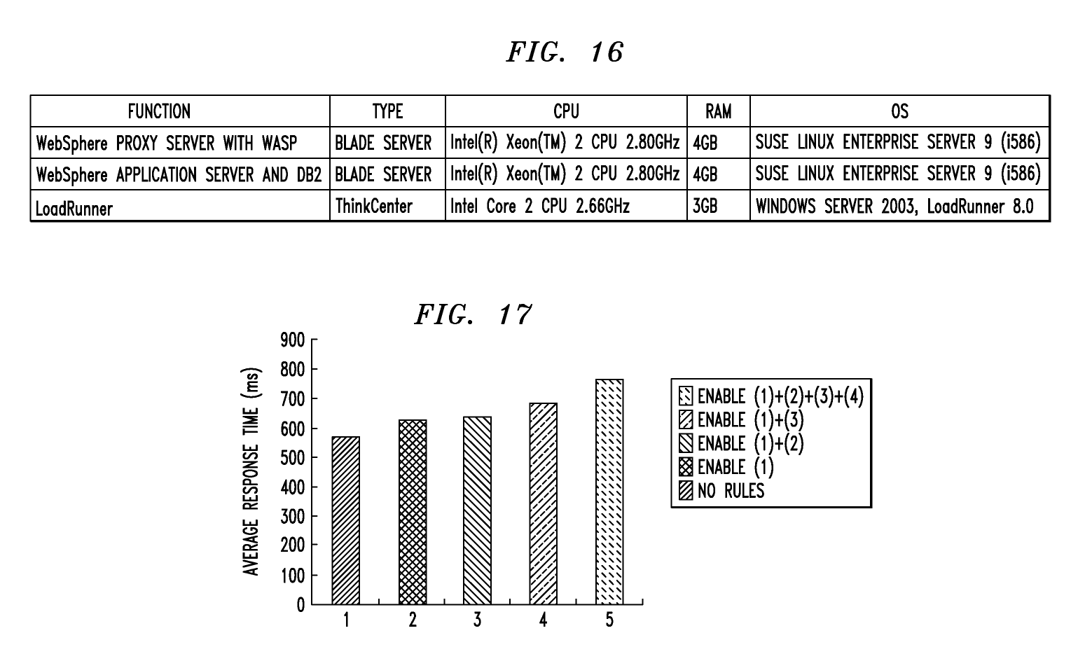

To evaluate the performance impact of WASP, experiments were conducted on 3-node machines connected via a high-speed LAN. As shown in the table of FIG. 16, one of the nodes is an Intel Core2 6700 2.66 GHz, 3G RAM machine with the Windows server 2003 operating system. Two of the nodes are Intel® Xeon® 2 CPU 2.80 GHz, 4G RAM machines with SUSE LINUX Enterprise Server 9. The nodes are connected to the Internet through a 1000M bps connection. The node with the Windows system is deployed with LoadRunner (version 8.0) and mimics client browsers, simulating multiple users by sending concurrent HTTP requests to the server application. Two of the nodes with SUSE are used on the server side to process HTTP requests. WASP is deployed on one of the nodes in the WebSphere proxy server (version 7); and the other node is deployed with a WebSphere application server (version 7) and IBM DB2® server (version 9.0) (registered mark of IBM). No other tasks were running on each node.

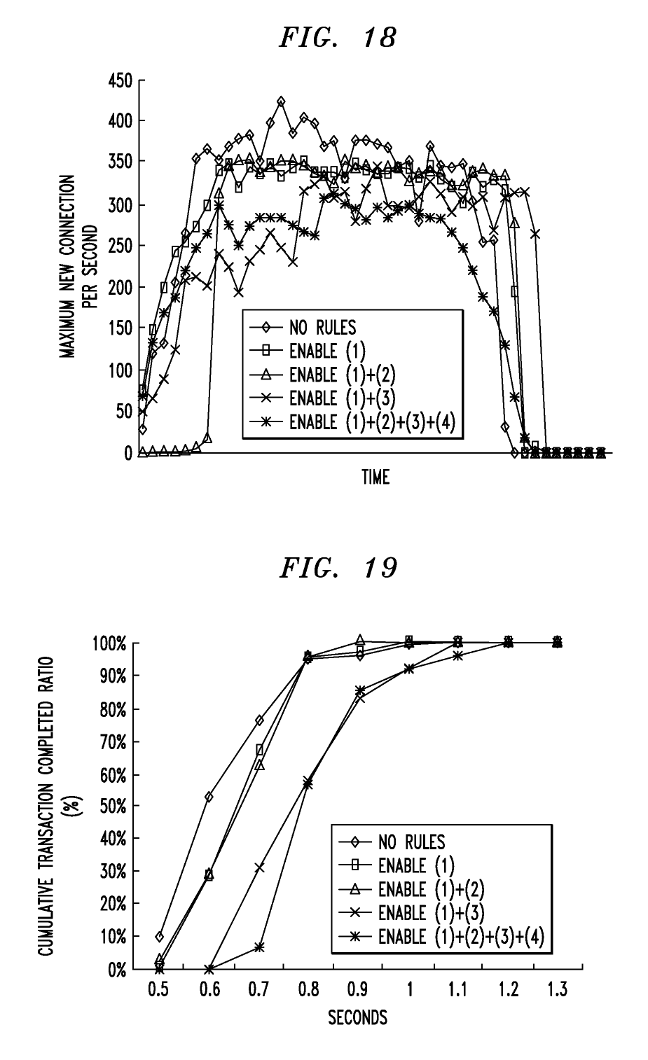

FIG. 17 shows average response time versus enabling different modules; FIG. 18 shows maximum new connections versus enabling different modules; and FIG. 19 shows the cumulative transaction completed ratio versus enabling different modules.

Based on the performance metric for application firewalls, three metrics, namely, Maximum New Connections per Second, Maximum Throughput per Second, and Average Response Time, are used for the performance impact evaluation. According to the WASP architecture shown in FIG. 4, the design of the test cases is based on estimation of the potential major bottlenecks in the WASP runtime. Based on the analysis of the WASP runtime code structure, the following four points are identified to be potential performance root causes and are tested in detail.
Condition operator: The regex matching for the positive pattern and negative pattern are implemented in the condition operator, to validate the users' input values. The negative pattern with long regex pattern will cost more computation resources.
Codecs module: The encoded characters such as Hex, Base64, and the like also can be executed as active content in client browsers to launch XSS attacks. The user input value will be sanitized and decoded in case the encoded characters are detected in this module.
RESTfull URL rewriting module: The RESTful URL in which the dynamic value is embedded will be rewritten to the static one based on the URL pattern, then follow the rule retrieving approach on the rewritten static one.
Response handler: To prevent CSRF attacks, some token(s) can be inserted to the response page to prevent the following forgery request based on the preissued token. This operation will increase some response latency.

The setting of the test cases is shown in the table of FIG. 13. FIG. 17 shows the average response time is 567 milliseconds without enabling rules in the WASP runtime engine, and the average response time will increase to 195 milliseconds after enabling all the modules in WASP, including the condition operator, codecs module, RESTful rewriting module, and response handler. Meanwhile the maximum new connections per second will decrease 22 percent with all the modules enabled in WASP as in FIG. 18. FIG. 19 plots the cumulative completed transaction ratio against time. Contrasting their performances, it can be seen that after 1000 ms, the success transaction completed ratio decreases from 100% for no rule enabled to 92% for all the modules enabled.

### Recapitulation

Web application firewalls adopt server-side application level firewalls to offer immediate assurances of security. Based on the evaluation criteria of Web application firewalls, the rule model and management, rule generation, and usability are significant aspects to the success of the WASF module.

Due consideration has been given to the firewall rule language defined in DataPower, ModSecurity, and the like, as well as the UML model defined in the WADL specification. One or more embodiments provide a WASP rule language HRS. One or more embodiments provide an HTTP message model defined in HRS, which supports URLTemplate, which can validate the dynamic input value embedded in dynamic URL, to support more REST message(s). HRS can express hierarchical fine-grain and semantically rich rules to prevent a broad class of attacks in HTTP request and response. Based on HRS, one or more embodiments implement the WASP rule management tool as a RESTful service to manage the JSON-based rule files. In addition, a rule transformation engine is implemented in the rule development tool, which can transform the WASP rules to IBM DataPower rules.

In one or more embodiments, four steps enable the virtual patching for firewall rules. Create the WASP rule template based on HRS and application context information. From application context information such as web.xml, struts.xml, or WADL file, retrieve the URLTemplate especially for the dynamic RESTful URL. For the rule generation, parse the XML report of a security testing tool, AppScan, to generateWASP messages and rules, which will be processed by the runtime WASP engine.

One or more embodiments bridge the gap between the firewall and back-end applications. For example, in some current techniques, when a non-compliant character is detected in a server-side firewall, a static error page is thrown out to the end user, which breaks the consistency of application logic and induces a bad user experience. The mechanism of smart error reporting, according to one or more embodiments, is different from these works, and is enabled in a runtime firewall engine to protect on boarding applications. One or more embodiments are consistent with the existing application logics and no modification of application codes is required. Instead of throwing out a static error page to end users when some violation is detected in a runtime WASP engine, a friendly error message and input backfill mechanism is designed to improve the user experience.

One or more embodiments provide a WASP rule language and meta-model to handle most aspects of HTTP requests and responses, including the application context. The application context is often encoded in one or more configuration files and/or annotations that are part of the backend methods. One or more embodiments use the application context to develop fine-grained and semantically rich WASF rules. Meanwhile, a rule development tool is provided in one or more embodiments to illustrate how to develop security rules based on the WASP rule language.

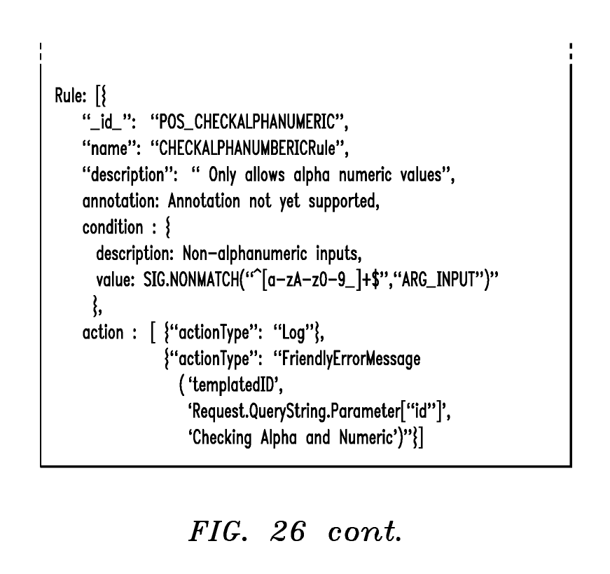

FIG. 26 shows a JSON representation for WASP security rules.

Virtual patching is a process in which a security administrator will develop and deploy one or more rules on a Web Application Firewall (WASF) to prevent any exploitation of application vulnerability. One or more embodiments provide a mechanism for provisioning rules using application context and testing tool results for interactive virtual patching. An experimental prototype has been developed in the context of a WASP project. Meanwhile, the smart error reporting mechanism in the context of WASP is provided by one or more embodiments. Rather than simply throwing out a static error page to end users when a violation is detected in the firewall, one or more embodiments provide usable security that provides friendly error messages with a backfill mechanism. The experimental evaluation shows that, in one or more embodiments, the user experience is improved by smart error reporting. Also, this mechanism is consistent with the existing application logic and no modification of application codes is required in at least some instances.

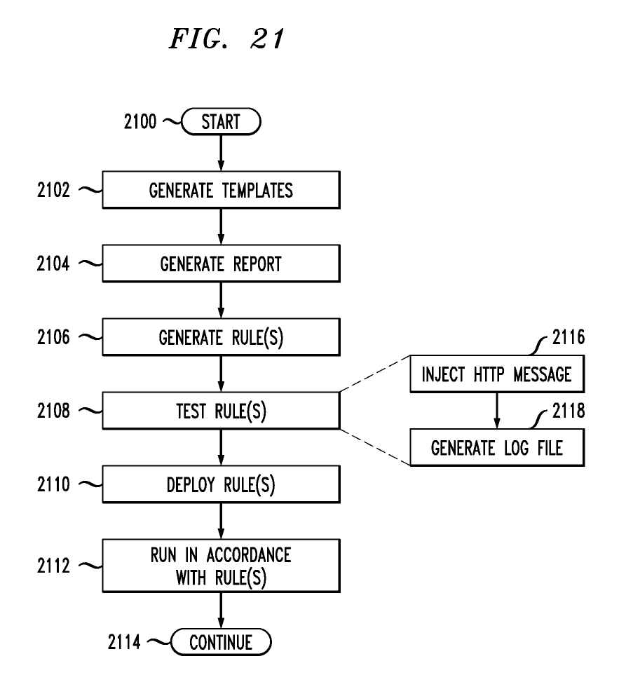

Reference should now be had to the flow chart of FIG. 21, which begins in step 2100. Given the discussion thus far, it will be appreciated that, in general terms, an exemplary method for interactive virtual patching of a web application includes the step 2102 of generating a plurality of templates for web application server firewall rules; the step 2104 of obtaining a vulnerability report for the web application (i.e., obtaining a report generated elsewhere or generating a report); and the step 2106 of generating at least one web application server firewall rule, using the vulnerability report and at least one of the plurality of templates. Furthermore, the method also includes the step 2108 of testing the at least one web application server firewall rule, and the optional step 2110 of deploying the at least one web application server firewall rule to run on the web application server firewall.

Processing continues at 2114.

In some cases, an additional step 2112 includes running the web application server firewall in accordance with the at least one web application server firewall rule.

In one or more embodiments, step 2102 includes generating the plurality of templates using a web application server firewall rule schema and application context information for the web application.

In some instances, in step 2102, the web application server firewall rule schema includes a hypertext transfer protocol message model and a rule model, and the application context information includes at least one of a configuration file and application annotations.

In some cases, step 2104 includes generating the vulnerability report with an application vulnerability scanning tool. In some such cases, generating the vulnerability report with the application vulnerability scanning tool includes identifying at least one of an application security issue and an infrastructure security issue.

Recall the URLTemplate for the Rest applications can be obtained by generating the rule template in Step 1, which parses the web.xml, struts.xml, and the like. Second, parse the vulnerability issues in the AppScan XML report to create WASP rule instances based on WASP rule schema, and then merge the URLTemplate value to the rule instances. The config of a REST application is always defined in the application's own config file, such as web.xml, struts.xml, and the like, so the REST information and URLTemplate meanings can be obtained from the config files. The appscan report always tells what vulnerabilities the scanned application has, including venue (which URL and which section in the http message). Thus, it is possible to translate this information to the rule definitions based on the rule schema. All findings for the same section on the same URL can be merged.

In one or more embodiments, the vulnerability report includes a hypertext transfer control protocol message, and step 2108 includes step 2116, injecting the hypertext transfer control protocol message into a testing environment, and step 2118, generating a log file to determine at least whether the at least one web application server firewall rule was fired in response to the injecting step.

As will be discussed further below, in some cases, the method further includes providing a system, wherein the system includes distinct software modules, each of the distinct software modules being embodied on a computer-readable storage medium. The modules can include, for example, a rule development tool (RDT) module 424; optionally, an application vulnerability scanning tool module (not illustrated separately; output depicted at 418—note that some instances do not use the appscan tool itself, but only use its generated report, that is, the output from appscan tool); and a runtime engine module 412. In such cases, step 2102 is carried out by the rule development tool module 424 executing on at least one hardware processor; step 2104 is carried out by the application vulnerability scanning tool module executing on the at least one hardware processor, or simply by using a report generated elsewhere; step 2106 is carried out by the rule development tool module executing on the at least one hardware processor; and step 2108 is carried out by the runtime engine module executing on the at least one hardware processor. At least one hardware processor includes, for example, all steps executing on a single processor, or, for example, steps 2102, 2106, and 2108 running on one processor, step 2104 running on another, and step 2112 running on another. Other combinations are possible. In some instances, deployment is facilitated by one or more human experts. In some instances, the rules are developed on one machine and deployed to run on one or more other machines.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Moderns, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for interactive virtual patching of a web application, said method comprising the steps of:
generating a plurality of templates for web application server firewall rules;
obtaining a vulnerability report for said web application;
generating at least one web application server firewall rule, using said vulnerability report and at least one of said plurality of templates;
testing said at least one web application server firewall rule; and
deploying said at least one web application server firewall rule to run on said web application server firewall.

2. The method of claim 1, wherein said step of generating said plurality of templates comprises generating said plurality of templates using a web application server firewall rule schema and application context information for said web application.

3. The method of claim 2, wherein, in said step of generating said plurality of templates:
said web application server firewall rule schema comprises a hypertext transfer protocol message model and a rule model; and
said application context information comprises at least one of a configuration file and application annotations.

4. The method of claim 2, wherein said step of obtaining said vulnerability report comprises generating said vulnerability report with an application vulnerability scanning tool.

5. The method of claim 4, wherein said step of generating said vulnerability report with said application vulnerability scanning tool comprises identifying at least one of an application security issue and an infrastructure security issue.

6. The method of claim 2, wherein:
said vulnerability report comprises a hypertext transfer control protocol message; and
said step of testing said at least one web application server firewall rule comprises:
injecting said hypertext transfer control protocol message into a testing environment; and
generating a log file to determine at least whether said at least one web application server firewall rule was fired in response to said injecting step.

7. The method of claim 1, wherein said step of obtaining said vulnerability report comprises generating said vulnerability report with an application vulnerability scanning tool, further comprising providing a system, wherein the system comprises distinct software modules, each of the distinct software modules being embodied on a computer-readable storage medium, and wherein the distinct software modules comprise a rule development tool module, an application vulnerability scanning tool module, and a runtime engine module;
wherein:
said generating of said plurality of templates is carried out by said rule development tool module executing on at least one hardware processor;
said generating of said vulnerability report is carried out by said application vulnerability scanning tool module executing on said at least one hardware processor;
said generating of said at least one web application server firewall rule is carried out by said rule development tool module executing on said at least one hardware processor; and
said testing of said at least one web application server firewall rule is carried out by said runtime engine module executing on said at least one hardware processor.

8. A method for interactive virtual patching of a web application, said method comprising the steps of:
generating a plurality of templates for web application server firewall rules;
obtaining a vulnerability report for said web application;
generating at least one web application server firewall rule, using said vulnerability report and at least one of said plurality of templates;
testing said at least one web application server firewall rule; and
providing a system, wherein the system comprises distinct software modules, each of the distinct software modules being embodied on a computer-readable storage medium, and wherein the distinct software modules comprise a rule development tool module and a runtime engine module;
wherein:
said generating of said plurality of templates is carried out by said rule development tool module executing on at least one hardware processor;
said generating of said at least one web application server firewall rule is carried out by said rule development tool module executing on said at least one hardware processor; and
said testing of said at least one web application server firewall rule is carried out by said runtime engine module executing on said at least one hardware processor.

9. The method of claim 8, wherein:
the system further comprises an application vulnerability scanning tool module; and
said obtaining of said vulnerability report is carried out by said application vulnerability scanning tool module executing on said at least one hardware processor.

10. The method of claim 9, wherein said step of generating said plurality of templates comprises generating said plurality of templates using a web application server firewall rule schema and application context information for said web application.

11. The method of claim 10, wherein, in said step of generating said plurality of templates:
said web application server firewall rule schema comprises a hypertext transfer protocol message model and a rule model; and
said application context information comprises at least one of a configuration file and application annotations.

12. The method of claim 9, wherein said vulnerability report identifies at least one of an application security issue and an infrastructure security issue.

13. The method of claim 9, wherein:
said vulnerability report comprises a hypertext transfer control protocol message; and
said step of testing said at least one web application server firewall rule comprises:
injecting said hypertext transfer control protocol message into a testing environment; and
generating a log file to determine at least whether said at least one web application server firewall rule was fired in response to said injecting step.

14. An article of manufacture comprising a computer program product for interactive virtual patching of a web application, said computer program product comprising:
a computer readable storage medium, storing in a non-transitory manner computer readable program code, the computer readable program code comprising:
computer readable program code configured to generate a plurality of templates for web application server firewall rules;
computer readable program code configured to obtain a vulnerability report for said web application;
computer readable program code configured to generate at least one web application server firewall rule, using said vulnerability report and at least one of said plurality of templates;
computer readable program code configured to test said at least one web application server firewall rule; and
computer readable program code configured to facilitate deploying said at least one web application server firewall rule to run on said web application server firewall.

15. The article of manufacture of claim 14, wherein said computer readable program code configured to generate said plurality of templates comprises computer readable program code configured to generate said plurality of templates using a web application server firewall rule schema and application context information for said web application.

16. The article of manufacture of claim 15, wherein:
said web application server firewall rule schema comprises a hypertext transfer protocol message model and a rule model; and
said application context information comprises at least one of a configuration file and application annotations.

17. The article of manufacture of claim 15, wherein said computer readable program code configured to obtain said vulnerability report comprises application vulnerability scanning tool computer readable program code configured to generate said vulnerability report.

18. The article of manufacture of claim 17, wherein said computer readable program code configured to generate said vulnerability report comprises computer readable program code configured to identify at least one of an application security issue and an infrastructure security issue.

19. The article of manufacture of claim 15, wherein:
said vulnerability report comprises a hypertext transfer control protocol message; and
said computer readable program code configured to test said at least one web application server firewall rule comprises:
computer readable program code configured to inject said hypertext transfer control protocol message into a testing environment; and
computer readable program code configured to generate a log file to determine at least whether said at least one web application server firewall rule was fired in response to said injecting step.

20. An article of manufacture comprising a computer program product for interactive virtual patching of a web application, said computer program product comprising:
a computer readable storage medium, storing in a non-transitory manner computer readable program code, the computer readable program code comprising:
computer readable program code configured to generate a plurality of templates for web application server firewall rules;
computer readable program code configured to obtain a vulnerability report for said web application;
computer readable program code configured to generate at least one web application server firewall rule, using said vulnerability report and at least one of said plurality of templates; and
computer readable program code configured to test said at least one web application server firewall rule.

21. The of manufacture of claim 20, wherein said computer readable program code configured to obtain said vulnerability report comprises application vulnerability scanning tool computer readable program code configured to generate said vulnerability report.

22. The article of manufacture of claim 21, wherein said computer readable program code configured to generate said plurality of templates comprises computer readable program code configured to generate said plurality of templates using a web application server firewall rule schema and application context information for said web application.

23. The article of manufacture of claim 22, wherein:
said web application server firewall rule schema comprises a hypertext transfer protocol message model and a rule model; and
said application context information comprises at least one of a configuration file and application annotations.

24. The article of manufacture of claim 21, wherein said vulnerability report identifies at least one of an application security issue and an infrastructure security issue.

25. The article of manufacture of claim 21, wherein:
said vulnerability report comprises a hypertext transfer control protocol message; and
said computer readable program code configured to test said at least one web application server firewall rule comprises:
computer readable program code configured to inject said hypertext transfer control protocol message into a testing environment; and
computer readable program code configured to generate a log file to determine at least whether said at least one web application server firewall rule was fired in response to said injecting step.
